(19) United States
(12) Patent Application Publication
(10) Pub. No.: US 2017/0334702 A1
(43) Pub. Date: Nov. 23, 2017

(54) INFRARED BASED BLENDING CONTROL

(71) Applicant: KHS USA, Inc., Marietta, GA (US)

(72) Inventor: David M. Kemp, Powder Springs, GA (US)

(21) Appl. No.: 15/474,002

(22) Filed: Mar. 30, 2017

Related U.S. Application Data
(60) Provisional application No. 62/316,961, filed on Apr. 1, 2016.

(51) Int. Cl. B67D 1/00; B01F 5/04; B67D 1/12; C12G 3/04

(52) U.S. Cl. CPC B67D 1/0032; C12G 3/04; B01F 5/0453; B67D 1/1211

(57) ABSTRACT

An apparatus for producing a blended alcoholic beverage includes a blender having first and second conduits for carrying respective first and second beverage ingredients, and corresponding flow-control valves for each conduit. These first and second conduits connect to a third conduit to form a blended stream that comprises the first ingredient and the second ingredient. An infrared sensor measures infrared absorption in the blended stream and provides a first signal to a controller that controls the flow-control valves based at least in part on the first signal.

### CROSS-REFERENCE TO RELATED APPLICATIONS

This application claims the benefit of U.S. Provisional Application No. 62/316,961 filed Apr. 1, 2016, and titled “Infrared Based Blending Control, which is incorporated herein by reference.

### FIELD OF INVENTION

This invention relates to blending ingredients to mass produce an alcoholic beverage, and in particular, to control concentrations of ingredients.

### BACKGROUND

In many jurisdictions, a government imposes a tax on alcoholic beverages. This tax very often depends on the overall proof of the beverage.

Many mass-produced alcoholic beverages are made by blending together various ingredients in the correct amounts. These beverages include flavored vodkas, cordials, and other spirit based drinks. The number of ingredients can vary. However, in most cases, there are on the order of six to fifteen separate conduits. These conduits typically include the underlying spirit, liquid sugars, flavors, acids, and other ingredients that contain different concentrations of alcohol.

The conventional procedure involves making a batch of the beverage by mixing together the ingredients in proportions that are as close as practicable to being correct, testing the concentrations of these ingredients, and adding ingredients on an as-needed basis to correct the mixture. Unless the batch is quite large, this procedure is not all that efficient for mass production.

To the extent a batch is large enough to make production more efficient, it becomes necessary to supply a very large tank. This raises capital costs.

### SUMMARY

The invention provides a way to continuously monitor concentrations of various ingredients as they are being blended together in real time, thus eliminating the need for a large storage tank and avoiding the inefficiency associated with batch processing.

In one aspect, the invention features an apparatus for producing a blended alcoholic beverage. Such an apparatus includes a blender having first and second conduits for carrying respective first and second beverage ingredients, and corresponding flow-control valves for each conduit. These first and second conduits connect to a third conduit to form a blended stream that comprises the first ingredient and the second ingredient. An infrared sensor measures infrared absorption in the blended stream and provides a first signal to a controller that controls the flow-control valves based at least in part on the first signal.

Embodiments include those that have a second infrared sensor disposed along the first conduit to measure infrared absorption of the first ingredient. In these embodiments, the controller receives a second signal from the second infrared sensor and controls the first and second flow-control valves based at least in part on the second signal.

In some embodiments, the first and second conduits connect to the third conduit through a static mixer.

Other embodiments include a pressure sensor disposed to measure pressure in the first conduit and to provide a pressure signal to the controller, or a temperature sensor disposed to measure temperature in the first conduit and to provide a temperature signal to the controller, or a mass flow meter disposed to measure flow rate in the first conduit and to provide a flow rate signal to the controller.

Also among the embodiments are those in which the first and second conduits connect to the third conduit directly, in the absence of any intermediate mixing tank or mixing chamber, to form the blended stream.

In another aspect, the invention features a method for producing an alcoholic beverage. Such a method includes carrying out in-line mixing of ingredients. In-line mixing includes conveying a first flow of a first ingredient, conveying a second flow of a second ingredient, combining the first and second flow to form a blended stream, measuring infrared absorption in the blended stream, providing first information indicative of infrared absorption of the blended stream, and based at least in part on the first information, controlling the first and second flows.

Some practices also include measuring one or more properties associated with the first ingredient or the first flow, providing second information indicative of those one or more properties, controlling the first and second flows based at least in part on the second information in addition to the first information. The properties in these embodiments can include infrared absorption, temperature, a mass flow rate, and pressure as examples.

In other practices, conveying a first flow of a first ingredient wherein combining the first and second flows to form a blended stream comprises passing the first and second flows into a static mixer. However, in other practices, no static mixer is used. Instead, the first and second flows are blended directly together.

### BRIEF DESCRIPTION OF THE FIGURES

These and other features and advantages of the invention will be apparent from the following detailed description and the accompanying figures, in which:

FIG. 1 shows a blender; and

FIG. 2 shows a blending system that includes multiple blenders as shown in FIG. 1.

### DETAILED DESCRIPTION

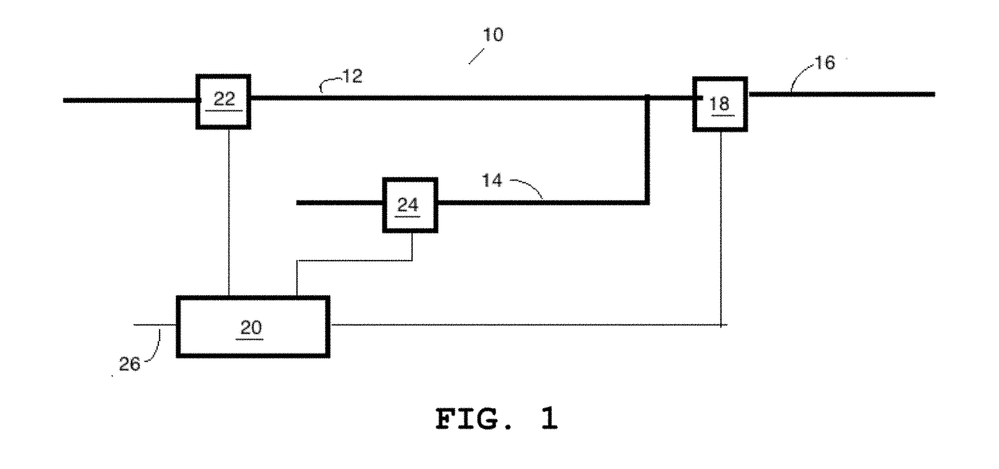

FIG. 1 shows a blender 10 having first and second conduits 12 14 carrying corresponding first and second streams of first and second ingredients. The first and second conduits 12, 14 connect to a third conduit 16 that carries a blended mixture of the first and second streams. A blended-stream infrared-sensor 18 in optical communication with the third conduit 16 measures how much the blended mixture absorbs infrared light and encodes that information in an absorption signal that it sends to a controller 20.

The first conduit 12 has a first flow-control valve 22 for adjusting flow rate of the first stream based on a first control-signal from the controller 20. Similarly, the second conduit 14 has a second flow-control valve 24 for adjusting flow rate of the second stream based on a second control-signal from the controller 20. As a result, the controller 20 is able to control flow rates of the first and second ingredients, and thereby control the composition of the blended mixture in the third conduit 16.

The controller 20 also has an external input 26 for providing it with a set point signal that identifies a desired proof for the blended mixture. Based on the externally supplied set-point signal and the absorption signal from the infrared sensor, the controller 20 executes a blend-control program 28 to calculate an error between a desired proof and a measured proof. It then generates first and second control signals to control the flow rates of the ingredients in order to achieve this desired proof.

The blender 10 shown in FIG. 1 thereby achieves continuous and real-time control over the proof of the blended mixture and does so by carrying out in-line blending or mixing with no intervening mixing tank or mixing chamber.

The blender 10 in FIG. 1 is a simple one with only first and second conduits 12, 14 for carrying first and second streams. However, the principles described herein are applicable to any number of conduits at the cost of some additional mathematical complexity. The mathematics associated with solving a problem with n ingredients is in principle no different from solving the problem with two ingredients and is well within the capability of anyone with nominal skills in multivariate algebra.

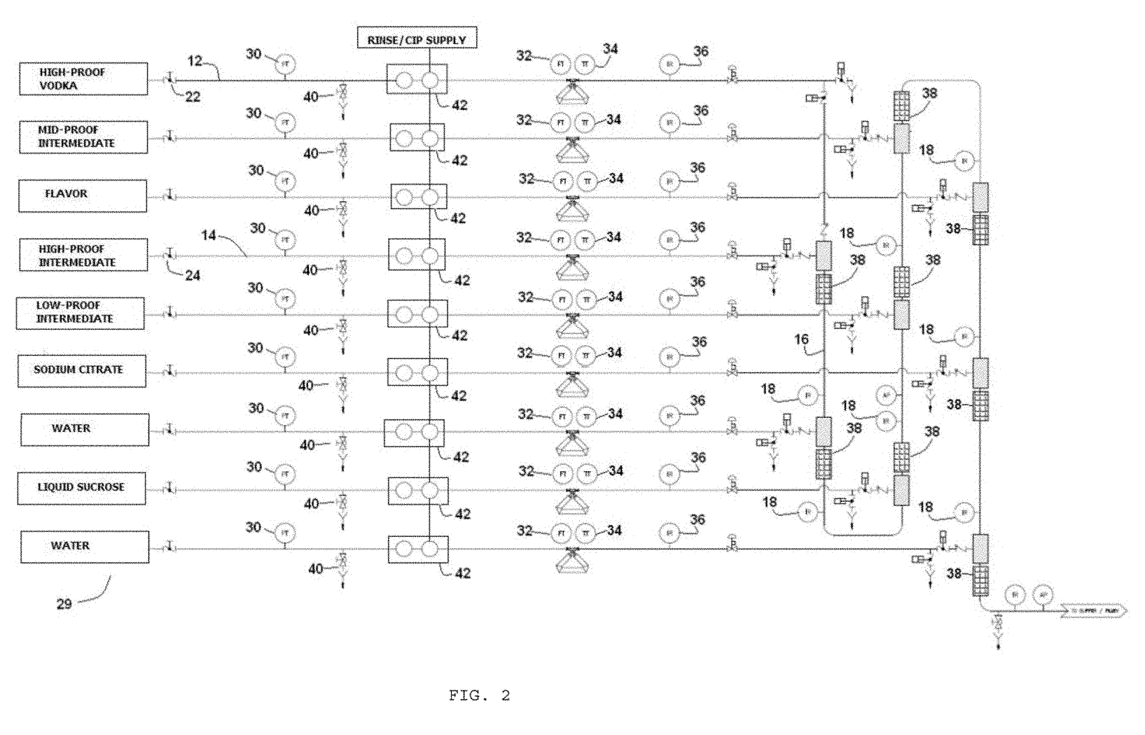

In addition, the blender 10 shown in FIG. 1 could be viewed as an elementary component of a blending system 29 as shown in FIG. 2 in which copies of the blender 10 shown in FIG. 1 are cascaded in series or connected in parallel.

For example, FIG. 2 has blenders 10 in which at least one of the first and second conduits 12, 14 carries blended mixtures output by at least one other blender of identical design. While this will introduce greater mathematical complexity, the mathematics involved is straightforward and well within the capability of anyone with nominal skills in multivariate algebra.

The blending system 29 shown in FIG. 2 includes the first and second conduits 12, 14 together with additional conduits that carry additional ingredients. Although FIG. 2 appears complex, it can be viewed as eight separate instances of the blender 10 shown in FIG. 1 that have been interconnected so that the output of one becomes an input to another.

The blending system 29 shown in FIG. 2 also has certain optional structures that have been omitted from FIG. 1 to promote clarity. For example, in FIG. 2, the first conduit 12 includes a pressure sensor 30 in series with a mass flow meter 32, a temperature sensor 34, and a supply-stream infrared sensor 36, all of which are in communication with the controller 20. Similar structures are associated with other conduits shown in FIG. 2. The the blend-control program 28 relies upon these signals in the course of generating control signals for controlling the various flow-control valves in FIG. 2.

The first and second conduits 12 lead to a static mixer 38, which in most embodiments is a tank containing stationary structures that interact with moving fluid to promote mixing thereof. Similar static mixers are associated with other pairs of conduits.

Since conduits must occasionally be drained, the first conduit 12 has a drainage system 40 that includes a forward-flow valve and a drain valve. In addition, since a conduit must occasionally be cleaned, the first stream also has a CIP interconnection 42 having a mix-proof valve. Similar drain valves and CIP interconnections are associated with the other conduits shown in FIG. 2,

Having described the invention, and a preferred embodiment thereof, what is claimed as new, and secured by letters patent is:

1. An apparatus for carrying out in-line mixing to produce a blended alcoholic beverage, said apparatus comprising a blender, said blender comprising a first conduit, a second conduit, a third conduit, a first flow-control valve, a second flow-control valve, a first infrared sensor, and a controller, wherein said first conduit carries a first ingredient of said beverage, wherein said second conduit carries a second ingredient of said beverage, wherein said first flow-control valve controls flow in said first conduit, wherein said second flow-control valve controls flow in said second conduit, wherein said first and second conduits connect to said third conduit to form a blended stream that comprises said first ingredient and said second ingredient, wherein said infrared sensor is disposed to measure infrared absorption in said blended stream, and wherein said controller is configured to receive a first signal from said first infrared sensor and to control said first and second flow-control valves based at least in part on said first signal.

2. The apparatus of claim 1, further comprising a second infrared sensor disposed along said first conduit to measure infrared absorption of said first ingredient, wherein said controller receives a second signal from said second infrared sensor and controls said first and second flow-control valves based at least in part on said second signal.

3. The apparatus of claim 1, further comprising a static mixer, wherein said first and second conduits connect to said third conduit through said static mixer.

4. The apparatus of claim 1, further comprising a pressure sensor disposed to measure pressure in said first conduit, wherein said pressure sensor provides a pressure signal to said controller.

5. The apparatus of claim 1, further comprising a temperature sensor disposed to measure pressure in said first conduit, wherein said temperature sensor provides a temperature signal to said controller.

6. The apparatus of claim 1, further comprising a mass flow meter disposed to measure flow rate in said first conduit, wherein said mass flow meter provides a flow rate signal to said controller.

7. The apparatus of claim 1, wherein said first and second conduits connect to said third conduit directly, in the absence of any intermediate mixing tank, to form said blended stream.

8. A method for producing an alcoholic beverage, said method comprising carrying out in-line mixing of ingredients, wherein in-line mixing comprises conveying a first flow of a first ingredient, conveying a second flow of a second ingredient, combining said first and second flow to form a blended stream, measuring infrared absorption in said blended stream, providing first information indicative of infrared absorption of said blended stream, and based at least in part on said first information, controlling said first and second flows.

9. The method of claim 8, further comprising measuring infrared absorption of said first ingredient, providing second information indicative of infrared absorption of said first ingredient, and controlling said first and second flows based at least in part on said second information in addition to said first information.

10. The method of claim 8, wherein conveying a first flow of a first ingredient wherein combining said first and second flow to form a blended stream comprises passing said first and second flows into a static mixer.

11. The method of claim 8, further comprising measuring a pressure in said first flow, providing second information indicative of said pressure, and controlling said first and second flows based at least in part on said second information in addition to said first information.

12. The method of claim 8, further comprising measuring a temperature in said first flow, providing second information indicative of said temperature, and controlling said first and second flows based at least in part on said second information in addition to said first information.

13. The method of claim 8, further comprising measuring a mass flow-rate in said first flow, providing second information indicative of said mass flow-rate, and controlling said first and second flows based at least in part on said second information in addition to said first information.

14. The method of claim 8, wherein combining said first and second flow to form a blended stream comprises combining said first and second flows directly in the absence of a static mixer
